(19) United States
(12) Patent Application Publication
(10) Pub. No.: US 2019/0351707 A1
(43) Pub. Date: Nov. 21, 2019

(54) PNEUMATIC TIRE

(71) Applicant: TOYO TIRE CORPORATION, Itami-shi, Hyogo (JP)

(72) Inventors: Tadaaki Miyabe, Itami-shi, Hyogo (JP); Takamichi Sunagawa, Itami-shi, Hyogo (JP); Koji Higashi, Itami-shi, Hyogo (JP)

(73) Assignee: TOYO TIRE CORPORATION, Itami-shi, Hyogo (JP)

(21) Appl. No.: 16/477,032

(22) PCT Filed: Jan. 19, 2018
(86) PCT No.: PCT/JP2018/001565

§ 371 Date: Jul. 10, 2019

(30) Foreign Application Priority Data
Jan. 20, 2017 (JP) 2017-008876
Jan. 20, 2017 (JP) 2017-008877
Jan. 20, 2017 (JP) 2017-008878
Jan. 20, 2017 (JP) 2017-008879
Jan. 20, 2017 (JP) 2017-008880
Jan. 20, 2017 (JP) 2017-008881
Jan. 20, 2017 (JP) 2017-008882

(51) Int. Cl. B60C 9/00; D02G 3/48; C08G 63/183; C08G 63/189; C08G 63/78

(52) U.S. Cl. CPC B60C 9/0042; D02G 3/48; B60C 2001/0066; C08G 63/189; C08G 63/78; C08G 63/183

(57) ABSTRACT

A pneumatic tire containing a polyester (e.g., polyethylene terephthalate or polyethylene naphthalate) derived from a non-fossil raw material. In a preferred embodiment, a polyester (e.g., polyethylene terephthalate or polyethylene naphthalate) in which a linear or cyclic moiety is produced using a raw material derived from a non-fossil raw material is used in the pneumatic tire. A pneumatic tire in which polyethylene terephthalate or polyethylene naphthalate produced using a raw material derived from a non-fossil raw material is used as a carcass material or a belt reinforcing material.

### TECHNICAL FIELD

The present invention relates to a pneumatic tire which is produced using, as a raw material, an environmental load reducing polyester, e.g., an environmental load-reducing polyethylene terephthalate or polyethylene naphthalate, derived from a non-fossil raw material.

The present invention also relates to a pneumatic tire in which an environmental load-reducing polyethylene terephthalate or polyethylene naphthalate which is derived from a non-fossil raw material is used as a carcass material.

The present invention also relates to a pneumatic tire in which an environmental load-reducing polyethylene terephthalate or polyethylene naphthalate which is derived from a non-fossil raw material is used as a belt reinforcing material.

### BACKGROUND OF THE INVENTION

Most polyesters used in pneumatic tires are produced from petroleum-derived raw materials. Most of the petroleum-derived polyesters are lightweight and stiff, has excellent durability, can be molded into any form easily, and can be mass-produced. Therefore, the polyesters enable pneumatic tires to exhibit excellent performance. However, when disposed in the environments, these polyesters cannot be decomposed easily and are therefore accumulated. When it is burnt, these polyesters release carbon dioxide in a large volume, and therefore accelerate global warming. In recent years, measures against serious environmental problems such as the decrease in fossil fuels and the increase in carbon dioxide in the atmosphere have been demanded. In the field of polyester to be used in tires, a polyester has been demanded, which is produced using a raw material derived from a non-fossil raw material and has reduced environmental loads.

Most polyethylene terephthalate compounds or polyethylene naphthalate compounds used in carcass materials are produced from petroleum-derived raw materials. Most of the polyethylene terephthalate compounds or polyethylene naphthalate compounds derived from petroleum are lightweight and stiff, has excellent durability, can be molded into any form easily, and can be mass-produced. Therefore, the polyethylene terephthalate compounds or polyethylene naphthalate compounds enable carcass materials to exhibit excellent performance. However, when disposed in the environments, these polyethylene terephthalate compounds or polyethylene naphthalate compounds cannot be decomposed easily and are therefore accumulated. When it is burnt, these polyethylene terephthalate compounds or polyethylene naphthalate compounds release carbon dioxide in a large volume, and therefore accelerate global warming. In recent years, measures against serious environmental problems such as the decrease in fossil fuels and the increase in carbon dioxide in the atmosphere have been demanded. In the field of polyethylene terephthalate or polyethylene naphthalate to be used in carcass materials, polyethylene terephthalate or polyethylene naphthalate has been demanded, which is produced using a raw material derived from a non-fossil raw material and has reduced environmental loads.

Most polyethylene terephthalate compounds or polyethylene naphthalate compounds used in belt reinforcing materials are produced from petroleum-derived raw materials.

Most of the polyethylene terephthalate compounds or polyethylene naphthalate compounds derived from petroleum are lightweight and stiff, has excellent durability, can be molded into any form easily, and can be mass-produced.

Therefore, the polyethylene terephthalate compounds or polyethylene naphthalate compounds enable carcass materials to exhibit excellent performance. However, when disposed in the environments, these polyethylene terephthalate compounds or polyethylene naphthalate compounds cannot be decomposed easily and are therefore accumulated. When it is burnt, these polyethylene terephthalate compounds or polyethylene naphthalate compounds release carbon dioxide in a large volume, and therefore accelerate global warming. In recent years, measures against serious environmental problems such as the decrease in fossil fuels and the increase in carbon dioxide in the atmosphere have been demanded. In the field of polyethylene terephthalate or polyethylene naphthalate to be used in belt reinforcing materials, polyethylene terephthalate or polyethylene naphthalate has been demanded, which is produced using a raw material derived from a non-fossil raw material and has reduced environmental loads.

A plant absorbs carbon dioxide in air during the growth thereof and fixes carbon through photosynthesis in the body thereof. Therefore, when a polyester (e.g., polyethylene terephthalate or polyethylene naphthalate) produced using the plant as a raw material is used and the plastic is burnt after the use, it is regarded that: the amount of carbon dioxide generated upon the burning is the same as that of carbon dioxide that has been absorbed by the plant, resulting in the occurrence of carbon neutral; and therefore, even when the polyester is burnt, the amount of carbon dioxide on the earth cannot be increased. For example, it is considered that a polyester produced using a plant as a raw material, e.g., polylactic acid, has little environmental loads.

In these situations, Japanese Patent Application Laid-open No. 2010-280750 discloses an environmental load-reducing polyester (e.g., polyethylene terephthalate or polyethylene naphthalate) which is produced using a non-fossil raw material as a main raw material and has excellent heat resistance. In Japanese Patent Application Laid-open No. 2010-280750, however, there is described no use of the environmental load-reducing polyester (e.g., polyethylene terephthalate or polyethylene naphthalate) in a tire, a carcass material or a member thereof.

Japanese Patent Application Laid-open No. 2008-290503 describes that a polyester (e.g., polyethylene terephthalate or polyethylene naphthalate) is used as a carcass material for a tire. However, Japanese Patent Application Laid-open No. 2008-290503 describes no origin of carbon constituting the polyester (e.g., polyethylene terephthalate or polyethylene naphthalate). Therefore, it is assumed that a polyester (e.g., polyethylene terephthalate or polyethylene naphthalate) derived from a fossil raw material is used in Japanese Patent Application Laid-open No. 2008-290503.

Japanese Patent Application Laid-open No. 5-338403 describes that polyethylene naphthalate or polyethylene naphthalate is used as a belt reinforcing material for a tire. However, Japanese Patent Application Laid-open No. 5-338403 also has no mention of the origin of carbon constituting the polyethylene naphthalate or polyethylene naphthalate. Therefore, it is assumed that polyethylene terephthalate or polyethylene naphthalate derived from a fossil raw material is used in Japanese Patent Application Laid-open No. 5-338403.

### SUMMARY OF THE INVENTION

The object of the present invention is to provide a pneumatic tire in which an environmental load reducing polyester (e.g., polyethylene terephthalate or polyethylene naphthalate) produced using a non-fossil raw material as a main raw material is used as a carcass material.

The wording “environmental load-reducing” as used herein refers to, for example, the matter that the substantial amount of carbon dioxide generated upon the burning of a polyester (e.g., polyethylene terephthalate or polyethylene naphthalate) is small.

In these situations, the present inventors have made intensive and extensive studies. As a result, it is found that, when a tire, a carcass material or a belt reinforcing material is produced using a polyester (e.g., polyethylene terephthalate or polyethylene naphthalate) derived from a non-fossil raw material, the performance of the tire, the carcass material or the belt reinforcing material is not deteriorated compared with the performance of a conventional tire, a conventional carcass material or a conventional belt reinforcing material produced using a polyester (e.g., polyethylene terephthalate or polyethylene naphthalate) derived from a fossil raw material. This finding leads to the accomplishment of the present invention.

The present invention provides: a pneumatic tire produced using a polyester derived from a non-fossil raw material; and a pneumatic tire in which polyethylene terephthalate or polyethylene naphthalate derived from a non-fossil raw material is used as a carcass material.

The polyester (e.g., polyethylene terephthalate or polyethylene naphthalate) for a pneumatic tire, a carcass material or a belt reinforcing material according to the present invention is made from a non-fossil raw material, and is polyester polyethylene terephthalate or polyethylene naphthalate having an intrinsic viscosity of 0.50 to 1.00 dL/g and a melting point of 230° C. or higher. Due to these constitutions, the polyester (e.g., polyethylene terephthalate or polyethylene naphthalate) can solve the above-mentioned problems.

Hereinbelow, in the whole amount of carbon atoms in an organic compound, the ratio of the concentration of ¹⁴C contained in the organic compound at the present time relative to the concentration of ¹⁴C in carbon cycle at the time point of year 1950 is defined as a “biotization rate” of the organic compound, wherein the concentration of ¹⁴C in carbon cycle at the time point of year 1950 is defined as 100%. The principle and procedures of the measurement of the concentration ratio are as mentioned below.

According to the present invention, it becomes possible to provide an environmental load-reducing pneumatic tire, carcass material or belt reinforcing material using an environmental load-reducing polyester (e.g., polyethylene terephthalate or polyethylene naphthalate) derived from a non-fossil raw material.

Namely, the effects of the present invention are as follows. The tire, the carcass material or the belt reinforcing material according to the present invention is such a tire, a carcass material or a belt reinforcing material that, when a constituent polyester (e.g., polyethylene terephthalate or polyethylene naphthalate) thereof is burnt, the substantial discharge amount of carbon dioxide generated during the burning is decreased by at least 400 g or more per 1 kg of, for example, polyethylene terephthalate or polyethylene naphthalate compared with a tire, a carcass material or a belt reinforcing material made from a polyester (e.g., polyethylene terephthalate or polyethylene naphthalate) produced using a fossil raw material and having the same chemical structure as that of the above-mentioned polyester (e.g., polyethylene terephthalate or polyethylene naphthalate). Consequently, it becomes possible to provide a tire, a carcass material or a belt reinforcing material which can be reduced in environmental loads and can exhibit the same performance as that of the conventional ones.

### DETAILED DESCRIPTION OF THE PREFERRED EMBODIMENTS

The polyester (e.g., polyethylene terephthalate or polyethylene naphthalate) according to the present invention, which is derived from a non-fossil raw material, can be used as a material such as a carcass material, a belt reinforcing material or the like which constitutes a pneumatic tire.

The polyester (e.g., polyethylene terephthalate or polyethylene naphthalate) derived from a non-fossil raw material can be produced by the same method as a method employed for the production of the conventional polyesters (e.g., polyethylene terephthalate or polyethylene naphthalate), except that a raw material derived from a non-fossil raw material is used, and can be used for the production of a pneumatic tire, a carcass material or a belt reinforcing material.

In the present invention, the term “raw material derived from a non-fossil raw material” refers to a raw material produced from a non-fossil biomass resource. The term “non-fossil biomass resource” as used herein refers to a regeneratable, biological-origin and carbon-neutral organic resource which is produced from water and carbon dioxide using a solar energy, and is different from a fossil resource produced from petroleum, coal, natural gas or the like. Namely, each of organic compounds and the like which serve as raw materials produced from non-fossil biomass resource are called as the above-mentioned non-fossil raw material.

The biomass resources that can be used in the present invention are classified into three types, i.e., a waste material, an unused material and a resource crop, based on the occurrence forms thereof. Examples of the biomass resource include a cellulosic crop (e.g., pulp, kenaf, wheat straw, rice straw, waste paper, a paper manufacturing residue), lignin, charcoal, compost, natural rubber, raw cotton, sugarcane, a fat or oil (e.g., rapeseed oil, cottonseed oil, soybean oil, coconut oil), glycerol, a carbohydrate crop (e.g., corn, potato, wheat, rice, cassava), bagasse, a terpenoid compound, black liquor, raw garbage, and wastewater sludge. The method for producing a glycol compound from a biomass resource is not particularly limited, and may be a known method including: a biological treatment method utilizing the action of a microorganism such as a fungi and a bacterium; a chemical treatment method utilizing an acid, an alkali, a catalyst, a thermal energy, a light energy or the like; and a physical treatment method such as micronization, compression, a microwave treatment and an electromagnetic wave treatment.

As the method for producing a polyester (e.g., polyethylene terephthalate or polyethylene naphthalate) from a biomass resource, various production methods can be mentioned. The production method is not particularly limited. Firstly, a biomass resource is subjected to a biological treatment method utilizing the action of a microorganism such as a fungi and a bacterium, a chemical treatment method utilizing an acid, an alkali, a catalyst, a thermal energy, a light energy or the like, or a physical treatment method such as micronization, compression, a microwave treatment and an electromagnetic wave treatment. Subsequently, a product produced by the production method is subjected to a hydrogen thermal decomposition reaction using a catalyst to purify the product. Alternatively, a method in which ethanol is produced from sugarcane, bagasse, a carbohydrate crop or the like by a biological treatment method and then a polyester is produced from ethanol through ethylene oxide may also be employed. Alternatively, a method in which a polyester is produced by the above-mentioned procedure and is then purified by a distillation operation or the like may also be employed.

Alternatively, as another method, a biomass resource is converted into glycerol, sorbitol, xylitol, glycol, fructose, cellulose or the like and then the resultant product is subjected to a hydrogenation thermal decomposition reaction using a catalyst to produce a mixture of ethylene glycol and 1,2-propane diol. Alternatively, a method can be mentioned, in which ethanol is produced from sugarcane, bagasse, a carbohydrate crop or the like by a biological treatment method, and then a mixture of ethylene glycol, diethylene glycol and triethylene glycol is produced from ethanol through ethylene oxide.

In the present invention, the term “biotization rate” refers to the ratio of the concentration of ¹⁴C in all of carbon atoms constituting the polyester (e.g., polyethylene terephthalate or polyethylene naphthalate) relative to the concentration of ¹⁴C in carbon cycle at the time point of year 1950, wherein the concentration of ¹⁴C in carbon cycle at the time point of year 1950 is defined as 100%. The concentration of ¹⁴C that is a radioactive carbon atom can be measured by a measurement method (a radioactive carbon concentration method) as mentioned below. Namely, the measurement of the concentration of ¹⁴C is a method in which an isotope (e.g., ¹²C, ¹³C, ¹⁴C) of carbon contained in a sample of interest is physically separated utilizing the difference in weight of the atoms with an accelerator by an accelerator mass spectrometry (AMS) using a combination of a tandem accelerator and a mass spectrometer and then the abundance of each atom of the isotope is measured.

In 1 mole (6.02×10²³ molecules) of a carbon atom, there is generally about 6.02×10¹¹ molecules of ¹⁴C that is about one trillionth of the number of the carbon atoms. ¹⁴C is called as a radioactive isotope, and the half-life thereof is 5730 years and is regularly decreased. For the complete decay of all of the atoms, 226000 years are required. Therefore, in a fossil fuel (e.g., coal, petroleum, natural gas) which it is considered to undergo the lapse of 226000 years or longer after the intake of carbon dioxide or the like in the atmosphere into a plant or the like and the fixation of the carbon dioxide or the like in the plant or the like, all of ¹⁴C elements contained in the fossil fuel at the beginning of the fixation are decayed. Therefore, at the present time, no ¹⁴C element is contained in a fossil fuel such as coal, petroleum and natural gas. As a result, a chemical substance produced using the fossil fuel as a raw material contains no ¹⁴C element. On the other hand, cosmic ray causes a nuclear reaction in the atmosphere to produce ¹⁴C continuously. Due to the balance between the continuous production of ¹⁴C and the decrease in ¹⁴C caused by radioactive decay, the quantity of ¹⁴C in the atmospheric environment of the earth becomes constant.

On the other hand, when carbon dioxide in the atmosphere is taken into a plant or an animal that feeds the plant and is therefore fixed in the plant or the animal, ¹⁴C is never replenished newly in this taken state, and the concentration of ¹⁴C decreases at a constant rate with the lapse of time in accordance with the half life of ¹⁴C. Therefore, it becomes possible to easily determine whether a compound is produced using a fossil resource as a raw material or using a biomass resource as a raw material by analyzing the concentration of ¹⁴C in the compound. The concentration of ¹⁴C is generally expressed using the concentration of ¹⁴C in carbon cycle in the nature at the time point of year 1950 as a modern standard reference, wherein this ¹⁴C concentration is defined as 100%. The concentration of ¹⁴C that is measured at the present days is a value around about 110 pMC (percent Modern Carbon). It is known that, when it is presumed that a plastic or the like which is used as a sample is produced from a substance derived from a 100% natural (biological) material, the concentration of ¹⁴C has a value of about 110 pMC. This value corresponds to the above-mentioned biotization rate of 100%. On the other hand, when the concentration of ¹⁴C is measured using a substance derived from a petroleum-based (fossil-based) material, the concentration of ¹⁴C is about 0 pMC. This value corresponds to the above-mentioned biotization rate of 0%. The mixing ratio of a substance derived from a natural material and a substance derived from a fossil material can be calculated using these values. As the modern standard reference that serves as a reference value for the concentration of ¹⁴C, an oxalic acid standard issued by National Institute of Standards and Technology (NIST) can be employed preferably. The specific radioactivity (i.e., the radioactive intensity of ¹⁴C per 1 g of carbon) of carbon in oxalic acid is fractionated for every carbon isotopes, and the value for ¹³C is corrected to a certain value, and a value obtained by decay compensation from year 1950 to the day of measurement is employed as a reference ¹⁴C concentration value.

In the method for analyzing the concentration of ¹⁴C in the polyester (e.g., polyethylene terephthalate or polyethylene naphthalate), a pretreatment of the polyester is required. More specifically, carbon atoms contained in the polyester (e.g., polyethylene terephthalate or polyethylene naphthalate) are subjected to an oxidization treatment to convert all of the carbon atoms to carbon dioxide. The resultant carbon dioxide is separated from water and nitrogen and then the carbon dioxide is reduced to convert the carbon dioxide to graphite that is a solid carbon material. The graphite thus produced is irradiated with a cation such as Cs⁺ to generate carbon negative ions. Subsequently, the carbon ions are accelerated with a tandem accelerator to charge-convert the carbon ions from negative ions to cations. Then, traveling orbits of ¹²C³⁺, ¹³C³⁺, ¹⁴C³⁺ are separated from one another with a mass spectrometric analysis electromagnet, and ¹⁴C³⁺ is measured with an electrostatic analyzer.

In the present invention, each of the polyester, the polyethylene terephthalate and the polyethylene naphthalate each produced by polymerization can be produced by a production method respectively using an aromatic dicarboxylic acid or a dialkyl ester of an aromatic dicarboxylic, terephthalic acid or a dialkyl ester of terephthalic acid and naphthalenedicarboxylic acid or a dialkyl ester of naphthalenedicarboxylic acid as a main raw material and also using ethylene glycol as a diol component.

As the aromatic dicarboxylic acid, terephthalic acid, naphthalenedicarboxylic acid or the like can be used preferably. An example of the dialkyl ester of an aromatic dicarboxylic acid is a lower dialkyl ester, e.g., a dimethyl ester, a diethyl ester, a dipropyl ester or a dibutyl ester, of an aromatic dicarboxylic acid. An example of the dialkyl ester of terephthalic acid is a lower dialkyl ester, e.g., a dimethyl ester, a diethyl ester, a dipropyl ester or a dibutyl ester, of terephthalic acid. An example of the dialkyl ester of naphthalenedicarboxylic acid is a lower dialkyl ester, e.g., a dimethyl ester, a diethyl ester, a dipropyl ester or a dibutyl ester, of naphthalenedicarboxylic acid.

The term “mainly” as used herein refers to the matter that other acid component may be polymerized in such an amount that the effects of the present invention cannot be affected substantially. An example of the copolymerizable component is a dicarboxylic acid generally used in a polyester including polyethylene terephthalate or polyethylene naphthalate. Specific preferred examples of the copolymerizable component include naphthalenedicarboxylic acid, 1,4-cyclohexanedicarboxylic acid, isophthalic acid, sodium 5-sulfoisophthalate and lower alkyl esters thereof. Most of these components are basically derived from fossil resources, and can be added together with other raw materials derived from fossil resources in the total amount of up to 10% by weight relative to the total amount of the raw materials for the polyester of the present invention.

In the production of the polyester (e.g., polyethylene terephthalate or polyethylene naphthalate) of the present invention, a trace amount of an additive may be added as required, such as a lubricant, an antioxidant agent, a solid-phase polymerization accelerator, a hue regulator, a fluorescent brightening agent, an antistatic agent, an antibacterial agent, an ultraviolet ray absorber, a light stabilizer, a heat stabilizer, a light-blocking agent and a delustering agent. However, most of these additives are basically derived from fossil resources. Therefore, the additives can be added together with other raw materials derived from fossil resources in the total amount of up to 10% by weight relative to the total amount of the raw materials for the polyester of the present invention.

The polyester (e.g., polyethylene terephthalate or polyethylene naphthalate) can be produced by any method, as long as a raw material derived from a non-fossil raw material is used. For example, polyethylene terephthalate can be produced through: a first-stage reaction of carrying out a direct esterification reaction of terephthalic acid with ethylene glycol derived from a non-fossil raw material or carrying out a transesterification reaction of dimethyl terephthalate with ethylene glycol derived from a non-fossil raw material to produce ethylene glycol ester of terephthalic acid and/or a low polymer thereof; and a second-stage reaction of heating the reaction product produced in the first-stage reaction under reduced pressure in the presence of a polymerization reaction catalyst to cause the polycondensation reaction of the reaction product until a desired polymerization degree can be achieved. For example, polyethylene naphthalate can be produced through: a first-stage reaction of carrying out a direct esterification reaction of naphthalenedicarboxylic acid with ethylene glycol derived from a non-fossil raw material or carrying out a transesterification reaction of a dialkyl ester of naphthalenedicarboxylic acid with ethylene glycol derived from a non-fossil raw material to produce ethylene glycol ester of naphthalenedicarboxylic acid and/or a low polymer thereof; and a second-stage reaction of heating the reaction product produced in the first-stage reaction under reduced pressure in the presence of a polymerization reaction catalyst to cause a polycondensation reaction of the reaction product until a desired polymerization degree can be achieved.

With respect to polyester or polyethylene terephthalate of the present invention, the percentage of carbon derived from dimethyl terephthalate is 80% (8 molecules) and the percentage of carbon derived from ethylene glycol is 20% (2 molecules) each relative to the amount of carbon atoms in the repeating unit constituting polyethylene terephthalate produced using dimethyl terephthalate or terephthalic acid as an acid component raw material. The matter that ethylene glycol having a biotization rate of 80% or more is used as a diol component means that carbon atoms including ¹⁴C derived from a non-fossil raw material makes up 80% or more of all of carbon atoms derived from ethylene glycol (i.e., 20% of all of carbon atoms constituting a repeating unit of polyethylene terephthalate) among all of carbon atoms constituting polyethylene terephthalate. Therefore, the theoretically calculated biotization rate of polyethylene terephthalate is 16% or more. The use of polyethylene terephthalate having a biotization rate of 16% or more is also one embodiment of the present invention.

For the achievement of the above-mentioned effects of the present invention, it is necessary to use polyethylene terephthalate having a biotization rate of 10% or more. If the biotization rate is less than 10%, the effects cannot be achieved sufficiently.

With respect to polyester or polyethylene naphthalate of the present invention, the percentage of carbon derived from 2,6-naphthalenedicarboxylic acid is 86% (12 molecules) and the percentage of carbon derived from ethylene glycol is 14% (2 molecules) each relative to the amount of carbon atoms in the repeating unit constituting polyethylene naphthalate produced using 2,6-naphthalenedicarboxylic acid or the like as an acid component raw material. The matter that ethylene glycol having a biotization rate of 80% or more is used as a diol component means that carbon atoms including ¹⁴C derived from a non-fossil raw material makes up 80% or more of all of carbon atoms derived from ethylene glycol (i.e., 14% of all of carbon atoms constituting a repeating unit of polyethylene naphthalate) among all of carbon atoms constituting the repeating unit of polyethylene naphthalate. Therefore, the theoretically calculated biotization rate of polyethylene terephthalate is 11% or more. The use of polyethylene naphthalate having a biotization rate of 11% or more is also one embodiment of the present invention.

For the achievement of the above-mentioned effects of the present invention, it is necessary to use polyethylene terephthalate or polyethylene naphthalate having a biotization rate of 10% or more. If the biotization rate is less than 10%, the effects cannot be achieved sufficiently.

It is preferred that the intrinsic viscosity of the produced polyester (e.g., polyethylene terephthalate or polyethylene naphthalate) falls within the range from 0.50 to 1.00 dL/g. If the intrinsic viscosity is less than 0.50 dL/g, the strength of a finished molded article may become very poor and therefore the molded article is not suitable for practical use. On the other hand, if the intrinsic viscosity is more than 1.00 dL/g, the melt viscosity may become too large and therefore moldability may be deteriorated extremely. The intrinsic viscosity is preferably 0.60 to 0.70 dL/g. As mentioned below, the intrinsic viscosity can be calculated from the viscosity of a solution having the polyester dissolved therein.

In the polymerization reaction for the polyester (e.g., polyethylene terephthalate or polyethylene naphthalate), a transesterification reaction catalyst or a polymerization reaction catalyst is generally used, and a heavy metal such as manganese, antimony and germanium can be used primarily. Specific examples of the catalysts include manganese acetate, antimony trioxide and germanium dioxide. A heavy metal has great environmental load. Therefore, in the present invention, it is more desirable to use a titanium catalyst that has relatively low environmental load. When dimethyl terephthalate is used as an acid component, ethylene glycol derived from a non-fossil raw material is used as a diol component and a titanium catalyst is used as a polymerization reaction catalyst, it becomes possible to provide a pneumatic tire, a carcass material or a belt reinforcing material which contains a polyester (e.g., polyethylene terephthalate or polyethylene naphthalate) which can further improve global environmental problems.

With respect to a titanium catalyst to be used as a polymerization reaction catalyst for the polyester or polyethylene terephthalate, a compound represented by Formula (I) or a product of the reaction of a compound represented by Formula (I) with an aromatic polycarboxylic acid represented by Formula (II) or an anhydride thereof can be mentioned preferably.

With respect to a titanium catalyst to be used as a polymerization reaction catalyst for polyethylene naphthalate, a compound represented by Formula (I) or a product of the reaction of a compound represented by Formula (I) with a 2,6-naphthalenedicarboxylic acid represented by Formula (II′) or an anhydride thereof can be mentioned preferably.

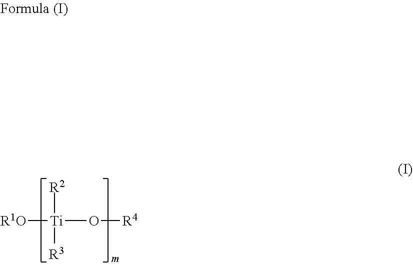

wherein R¹, R², R³ and R⁴ may be the same as or different from one another and independently represent an alkyl group or a phenyl group, and m represents an integer of 1 to 4, wherein, when m represents an integer of 2 to 4, 2 to 4 R²'s and R³'s may be the same as or different from one another.

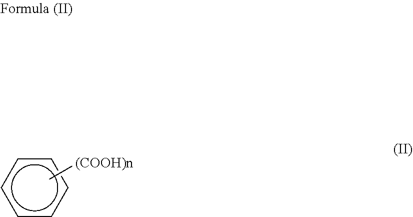

wherein n represents an integer of 2 to 4.

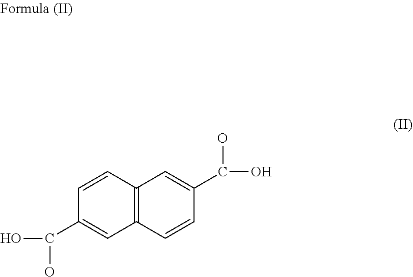 [SMILES: OC(O)c1ccc2cc(C(O)O)ccc2c1]

Specific examples of the titanium compound represented by formula (I) include a titanium tetraalkoxide such as titanium tetraethoxide, titanium tetraisopropoxide, titanium tetra-n-propoxide and titanium tetrabutoxide, and also include titanium tetraphenoxide, hexaethyl dititanate, hexapropyl dititanate, hexabutyl dititanate, hexaphenyl dititanate, octaethyl trititanate, octapropyl trititanate, octabutyl trititanate and octaphenyl trititanate. As the aromatic polycarboxylic acid represented by formula (II) or an anhydride thereof, phthalic acid, trimellitic acid, hemimellitic acid, pyromellitic acid and anhydrides thereof can be used preferably.

In the case where the titanium compound is reacted with the aromatic polycarboxylic acid or an anhydride thereof, the reaction is carried out in such a manner that a portion or the whole of the aromatic polycarboxylic acid or the anhydride thereof is dissolved in a solvent to produce a mixed solution, then titanium compound is dropwise added to the mixed solution, and then the resultant mixture is heated at a temperature of 0 to 200° C. for at least 30 minutes, preferably at a temperature of 30 to 150° C. for 40 to 90 minutes. The reaction pressure to be employed in the reaction is not particularly limited, and ambient pressure is sufficient. As the solvent to which the aromatic polycarboxylic acid or the anhydride thereof is to be dissolved, any one selected from ethanol, ethylene glycol, trimethylene glycol, tetramethylene glycol, benzene, xylene and the like may be used as required.

The reaction molar ratio between the titanium compound and the aromatic polycarboxylic acid or the anhydride thereof is not particularly limited. However, if the molar ratio of the titanium compound is too large, the hue of a polyester produced using this compound as a catalyst may be deteriorated and the softening point may be lowered. If the molar ratio of the titanium compound is too small, the polycondensation reaction may not proceed in the polyester production step. For these reasons, it is preferred that the reaction molar ratio between the titanium compound and the aromatic polycarboxylic acid or the anhydride thereof is 2/1 to 2/5, particularly preferably 2/2 to 2/4.

It is preferred that the amount of titanium element soluble in a polyester (e.g., polyethylene terephthalate or polyethylene naphthalate) which is contained in the polyester (e.g., polyethylene terephthalate or polyethylene naphthalate) of the present invention is 5 to 70 ppm relative to the total amount of all of dicarboxylic acid components. With respect to the term “titanium element soluble in a polyester (e.g., polyethylene terephthalate or polyethylene naphthalate)” as used herein, it is meant that Ti element which, when added in the form of inorganic particles, like titanium dioxide, in the polyester (e.g., polyethylene terephthalate or polyethylene naphthalate), can be present in the polyester (e.g., polyethylene terephthalate or polyethylene naphthalate) without being mixed with the polyester (e.g., polyethylene terephthalate or polyethylene naphthalate) homogeneously does not correspond. More specifically, titanium element contained in an organic Ti-based catalyst or the like corresponds to a titanium element soluble in a polyester (e.g., polyethylene terephthalate or polyethylene naphthalate). Still more specifically, the term “titanium element soluble in a polyester (e.g., polyethylene terephthalate or polyethylene naphthalate)” as used herein does not include an inorganic titanium compound that is added for delustering purposes (e.g., titanium dioxide), and refers to an organic titanium compound which has been generally used as a catalyst or an organic titanium compound which is contained as an impurity in titanium dioxide that is used as a delustering agent. If the amount of the titanium element soluble in a polyester (e.g., polyethylene terephthalate or polyethylene naphthalate) is less than 5 ppm, the polycondensation reaction is delayed. If the amount of the titanium element is more than 70 ppm, the hue of the resultant polyester (e.g., polyethylene terephthalate or polyethylene naphthalate) may be deteriorated, and the heat resistance thereof may also be deteriorated undesirably. The amount of the titanium element is preferably 7 to 60 ppm, more preferably 10 to 50 ppm, relative to the amount of the polyester (e.g., polyethylene terephthalate or polyethylene naphthalate).

In the production of the polyester (e.g., polyethylene terephthalate or polyethylene naphthalate) of the present invention, any phosphorus compound can be added in addition to a transesterification catalyst and a polycondensation catalyst. The type of the phosphorus compound is not particularly limited. For example, particularly in the case where a titanium-based catalyst is used, it is preferred that a phosphorus compound represented by Formula (III) is added at any stage.

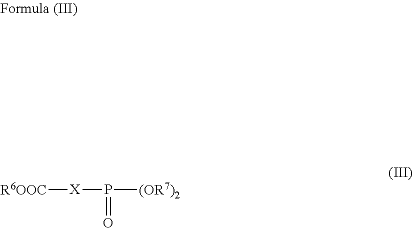

wherein R⁶ and R⁷ may be the same as or different from each other and independently represent an alkyl group having 1 to 4 carbon atoms; and X represents —CH₂— or —CHPh-.

The phosphorus compound (phosphonate compound) represented by Formula (III) is preferably selected from dimethyl esters, diethyl esters, dipropyl esters and dibutyl esters of carbomethoxymethanephosphonic acid, carboethoxymethanephosphonic acid, carbopropoxymethanephosphonic acid, carbobutoxymethanephosphonic acid, carbomethoxy-phosphonophenylacetic acid, carboethoxy-phosphonophenylacetic acid, carbopropoxy-phosphonophenylacetic acid and carbobutoxy-phosphonophenylacetic acid. Among these compounds, more preferred is carbomethoxymethanephosphonic, dimethyl carbomethoxymethanephosphonate, diethyl carbomethoxymethanephosphonate, carboethoxymethanephosphonic acid, dimethyl carboethoxymethanephosphonate or diethyl carboethoxymethanephosphonate. Each of these phosphonate compounds enables the relatively mild proceed of the reaction with the titanium compound compared with a phosphorus compound that has been commonly used as a stabilizer. As a result, the time of duration of the catalytic activity of the titanium compound in the reaction is prolonged, resulting in the reduction in the amount of the titanium compound to be added to the polyester (e.g., polyethylene terephthalate or polyethylene naphthalate).

It is preferred that the catalyst system containing the titanium compound satisfies the requirements respectively expressed by mathematical formulae (1) and (2) simultaneously.

0.65≤P/Ti≤5.0 (1)

10≤P+Ti≤200 (2)

[In mathematical formulae (1) and (2), Ti represents the concentration (ppm by weight) of metal titanium element which is contained in the polyester (e.g., polyethylene terephthalate or polyethylene naphthalate) and is soluble in a polyester (e.g., polyethylene terephthalate or polyethylene naphthalate); and P represents the concentration (ppm by weight) phosphorus element in the phosphorus compound contained in the polyester (e.g., polyethylene terephthalate or polyethylene naphthalate).]

If the (P/Ti) value is less than 0.65, the hue of the polyester (e.g., polyethylene terephthalate or polyethylene naphthalate) may take on a yellow tinge, which is not preferred. If the (P/Ti) value is more than 5.0, the reactivity of the polymerization for the polyester (e.g., polyethylene terephthalate or polyethylene naphthalate) may be greatly reduced, and consequently it may become difficult to produce the desired polyester (e.g., polyethylene terephthalate or polyethylene naphthalate). It is characteristic that the proper range of the (P/Ti) value is narrower than those for the conventional metal catalyst systems. When the (P/Ti) value falls within the proper range, non-conventional effects of the present invention can be achieved. If the (Ti+P) value is less than 10, the productivity in a yarn-making process may be reduced greatly, and consequently satisfactory performance may not be achieved. If the (Ti+P) value is more than 200, foreign substances coming from the catalyst may be produced undesirably, although in a trace amount. With respect to the ranges of mathematical formulae (1) and (2), it is preferred that the (P/Ti) value in formula (1) is 1.0 to 4.5 and the (Ti+P) value in formula (2) is 12 to 150, and it is more preferred that the (P/Ti) value in formula (1) is 2.0 to 4.0 and the (Ti+P) value in formula (2) is 15 to 100. In the production method according to the present invention, it is preferred that the polymerization reaction to be carried out using the catalyst system is carried out for 15 to 300 minutes under conditions where a temperature of 230 to 320° C. and a pressure of ambient pressure or a reduced pressure, preferably 0.05 Pa to 0.2 MPa are combined.

When the polyester (e.g., polyethylene terephthalate or polyethylene naphthalate) produced by the present invention is finally burnt, the amount of carbon dioxide generated during the burning can be substantially reduced. The reason for this is as follows. As mentioned above, a plant absorbs carbon dioxide in air during the growth thereof and fixes carbon through photosynthesis in the body thereof. Therefore, when a plastic produced using the plant as a raw material is used and the plastic is burnt after the use, it is regarded that: the amount of carbon dioxide generated upon the burning is the same as that of carbon dioxide that has been absorbed by the plant, resulting in the occurrence of carbon neutral; and therefore, even when the plant is burnt, the amount of carbon dioxide on the earth cannot be increased substantially. The amount of carbon dioxide generated during complete burning can be determined by calculation. For example, when 1 constituent unit of polyethylene terephthalate (PET) (molecular weight 192.1) is completely burnt, a 10-fold molar amount of CO₂ (molecular weight 44.0) is generated, and the amount of generated carbon dioxide can be determined in accordance with mathematical formula (3).

Amount (g) of generated carbon dioxide CO₂=(weight (g) of burnt PET)/192.1×10×44 (3)

With taking the concept of carbon neutral into consideration, when ethylene glycol is derived from a biomass and 1 constituent unit of PET is completely burnt, it is considered that an 8-fold molar amount of CO₂ excluding the amount coming from ethylene glycol is generated. Therefore, when ethylene glycol derived from a biomass is used, the amount of generated carbon dioxide can be determined in accordance with mathematical formula (4).

Amount (g) of generated carbon dioxide CO₂=(weight (g) of burnt PET)/192.1×8×44 (4)

In the case where the polymer is polyethylene naphthalate (PEN), when 1 constituent unit of PEN (molecular weight 242.2) is completely burnt, a 14-fold molar amount of CO₂ (molecular weight 44.0) is generated. Therefore, the amount of generated carbon dioxide can be determined in accordance with mathematical formula (5).

Amount (g) of generated carbon dioxide CO₂=(weight (g) of burnt PEN)/242.2×14×44 (5)

As in the case of the above-mentioned PET, when ethylene glycol is derived from a biomass, the amount of generated carbon dioxide can be determined in accordance with mathematical formula (6).

Amount (g) of generated carbon dioxide CO₂=(weight (g) of burnt PEN)/242.2×12×44 (6)

Therefore, when biomass-derived ethylene glycol is used, the substantial carbon dioxide discharge amount can be reduced by 300 g or more per 1 kg of polyester (e.g., polyethylene terephthalate or polyethylene naphthalate) compared with conventional polyesters (e.g., polyethylene terephthalate or polyethylene naphthalate).

In the present invention, it is required that a non-fossil raw material makes up 20% by weight or more of the total amount of the components constituting the polyester (e.g., polyethylene terephthalate or polyethylene naphthalate). The term “non-fossil raw material” refers to an organic compound which can be used as a raw material produced from a biomass resource, as mentioned above. From the studies made by the present inventors, the above-mentioned effects of the present invention can be achieved when a polyester (e.g., polyethylene terephthalate or polyethylene naphthalate) having a non-fossil raw material content ratio of 20% by weight or more in the polyester (e.g., polyethylene terephthalate or polyethylene naphthalate) is used, and the above-mentioned effects of the present invention cannot be achieved satisfactorily when a polyester (e.g., polyethylene terephthalate or polyethylene naphthalate) having a non-fossil raw material content ratio of less than 20% by weight in the polyester (e.g., polyethylene terephthalate or polyethylene naphthalate) is used. As one example, the case where the polymer is polyethylene terephthalate (PET) and the ethylene glycol moiety thereof is derived from a biomass corresponds to the case where the ethylene glycol moiety is made from a non-fossil raw material. In this case, the weight ratio of the non-fossil raw material in the polyester can be expressed by formula (7).

(Molecular weight of EG moiety in 1 constituent unit of PET)/(molecular weight of 1 constituent unit of PET)=60/192.1×100=31.2% (7)

In the case where the polymer is polyethylene naphthalate (PEN) and the ethylene glycol moiety thereof is derived from a biomass, the weight ratio of the non-fossil raw material in the polyester can be calculated in accordance with formula (8).

(Molecular weight of EG moiety in 1 constituent unit of PEN)/(molecular weight of 1 constituent unit of PEN)=60/242.2×100=24.8% (8)

The non-fossil raw material preferably makes up 24% by weight or more, more preferably 31% by weight of more, of the total amount of the components constituting the polyester (e.g., polyethylene terephthalate or polyethylene naphthalate). When these requirements are satisfied, the polyester (e.g., polyethylene terephthalate or polyethylene naphthalate) of the present invention can achieve the substantial reduction in the amount of generated carbon dioxide.

As mentioned above, according to the present invention, it becomes possible to provide: such a polyester (e.g., polyethylene terephthalate or polyethylene naphthalate) that the amount of carbon dioxide generated during the burning of the polyester (e.g., polyethylene terephthalate or polyethylene naphthalate) is reduced compared with the case where a fossil raw material is used and that the environmental load is reduced; and a pneumatic tire made from the polyester (e.g., polyethylene terephthalate or polyethylene naphthalate).

### EXAMPLES

The present invention will be described more specifically by way of examples. However, the present invention is not limited by these examples.

Tires and tire members were produced using polyethylene terephthalate (PET) and polyethylene naphthalate (PEN) produced using raw materials derived from conventional fossil raw materials and raw materials derived from non-fossil raw materials, and tests on the performance of the tires and the tire members were carried out.

TABLE 1

| | | C. Ex. 1 | Ex. 1 | C. Ex. 2 | Ex. 2 |
|---|---|---|---|---|---|
| Material | | Petroleum- | Bio-derived | Petroleum- | Bio-derived |
| | | derived PET | PET | derived PEN | PEN |
| Biotization rate | | 0% | 100% | 0% | 20% |
| Constitution of cord | | 1100 dtex/2 | | 1670 dtex/2 | |
| Count of second twists | T/10 cm | 46.0 | 45.8 | 37.5 | 37.7 |
| Diameter of cord | mm | 0.55 | 0.55 | 0.67 | 0.67 |
| Fineness | dtex | 2525 | 2530 | 3375 | 3377 |
| Strength | N | 139 | 141 | 210 | 209 |
| Elongation at breaking | % | 13.9 | 14.0 | 9.2 | 9.3 |
| EASL@2cN/dtex | % | 4.0 | 4.1 | 2.3 | 2.3 |
| Dry heat shrinkage ratio | % | 3.1 | 2.8 | 3.2 | 3.1 |
| T-pull adhesion | N/cm | 115 | 118 | 168 | 165 |
| Fatigue of disc | % | 93 | 91 | 72 | 73 |
| Tire size | | 205/65R 16 95H | | 235/50 Z R 17 96Y | |
| Belt-reinforcing | Material | Ny66 | | Petroleum- | Bin-derived |
| cord | | | | derived PEN | PEN |
| | Constitution | 940 dtex/2-50 cords/50 mm | | 1670 dtex/ | 1670 dtex/ |
| | | | | 2-40 cords/ | 2-40 cords/ |
| | | | | 50 mm | 50 mm |
| Belt | Material | Steel cord | | Steel cord | |
| | Constitution | 2 + 2 × 0.25 36 cords/50 mm | | 2 + 2 × 0.25 36 cords/50 mm | |
| Carcass cord | Material | Petroleum- | Bio-derived | Rayon | Rayon |
| | | derived PET | PET | | |
| | Constitution | 1100 dtex/ | 1100 dtex/ | 1840 dtex/ | 1840 dtex/ |
| | | 2-50 cords/ | 2-50 cords/ | 2-50 cords/ | 2-50 cords/ |
| | | 50 mm × | 50 mm × | 50 mm × | 50 mm × |
| | | 2 sheets | 2 sheets | 2 sheets | 2 sheets |
| General | Distance of run | 2754 km | 2754 km | 2754 km | 2754 km |
| durability | Failure state | no failure | no failure | no failure | no failure |
| Post-test strength retention rate | | 100% | 100% | 100% | 99% |
| High-speed | Result | 240 km × 10 min | 240 km × 10 min | 330 km × 10 min | 330 km × 10 min |
| durability | Failure state | no failure | no failure | no failure | no failure |
| Post-test strength retention rate | | 100% | 100% | 97% | 97% |
| Handling | Dry | 3 | 3 | 3 | 3 |
| stability | Wet | 3 | 3 | 3 | 3 |

TABLE 2

| | | C. Ex. | Ex. |
|---|---|---|---|
| Material | | Petroleum-derived PET | Bio-derived PET |
| Biotization rate | | 0% | 100% |
| Constitution of cord | | 1100 dtex/2 | |
| Count of second twists | T/10 cm | 46.0 | 45.8 |
| Diameter of cord | mm | 0.55 | 0.55 |
| Fineness | dtex | 2525 | 2530 |
| Strength | N | 139 | 141 |
| Elongation at breaking | % | 13.9 | 14.0 |
| EASL@2cN/dtex | % | 4.0 | 4.1 |
| Dry heat shrinkage ratio | % | 3.1 | 2.8 |
| T-pull adhesion | N/cm | 115 | 118 |
| Fatigue of disc | % | 93 | 91 |
| Tire size | | 205/65R 16 95H | |
| Belt-reinforcing | Material | Petroleum-derived PET | Bio-derived PET |
| cord | Constitution | 1100 dtex/2-50 cords/50 mm | 1100 dtex/2-50 cords/50 mm |
| Belt | Material | Steel cord | |
| | Constitution | 2 + 2 × 0.25 36 cords/50 mm | |
| Carcass cord | Material | Rayon | |
| | Constitution | 1840 dtex/2-50 cords/50 mm × 2 sheets | |
| General | Distance of run | 2754 km | 2754 km |
| durability | Failure state | no failure | no failure |
| Post-test strength retention rate | | 100% | 99% |
| High-speed | Result | 240 km × 10 min | 240 km × 10 min |
| durability | Failure state | no failure | no failure |
| Post-test strength retention rate | | 98% | 98% |
| Handling | Dry | 3 | 3 |
| stability | Wet | 3 | 3 |

TABLE 3

| | | C. Ex. | Ex. |
|---|---|---|---|
| Material | | Petroleum-derived PEN | Bio-derived PEN |
| Biotization rate | | 0% | 20% |
| Constitution of cord | | 1670 dtex/2 | |
| Count of second twists | T/10 cm | 37.5 | 37.7 |
| Diameter of cord | mm | 0.67 | 0.67 |
| Fineness | dtex | 3375 | 3377 |
| Strength | N | 210 | 209 |
| Elongation at breaking | % | 9.2 | 9.3 |
| EASL@2cN/dtex | % | 2.3 | 2.3 |
| Dry heat shrinkage ratio | % | 3.2 | 3.1 |
| T-pull adhesion | N/cm | 168 | 165 |
| Fatigue of disc | % | 72 | 73 |
| Tire size | | 235/50Z R17 96Y | |
| Belt-reinforcing | Material | Ny66 | |
| cord | Constitution | 1400 dtex/2-50 cords/50 mm | |
| Belt | Material | Steel cord | |
| | Constitution | 2 + 2 × 0.25 36 cords/50 mm | |
| Carcass cord | Material | Petroleum-derived PEN | Bio-derived PEN |
| | Constitution | 1670 dtex/2-40 cords/ | 1670 dtex/2-40 cords/ |
| | | 50 mm × 2 sheets | 50 mm × 2 sheets |
| General | Distance of run | 2754 km | 2754 km |
| durability | Failure state | no failure | no failure |
| Post-test strength retention rate | | 100% | 99% |
| High-speed | Result | 330 km × 10 min | 330 km × 10 min |
| durability | Failure state | no failure | no failure |
| Post-test strength retention rate | | 100% | 100% |
| Handling | Dry | 3 | 3 |
| stability | Wet | 3 | 3 |

The methods for the measurements are as follows.
Biotization rate: The concentration of ¹⁴C contained in a cord is measured in accordance with Method B prescribed in ASTM D6866, and then the ratio of the concentration of the ¹⁴C relative to the concentration of ¹⁴C that is radioactive carbon in carbon cycle at the time point of year 1950 (which is defined as 100%) is determined.
Count of second twists: The Count of second twists is determined in accordance with JIS L1017.
Diameter of cord: the diameter of a cord is determined in accordance with JIS L1017.
Fineness: The fineness based on corrected mass is determined in accordance with JIS L1017.
Strength: A tensile test is carried out in accordance with JIS L1017, and a load upon the breaking of a cord is measured.
Elongation at breaking: A tensile test is carried out in accordance with JIS L1017, and an elongation rate at the breaking of a cord is measured.
EASL@2 cN/dtex: A tensile test is carried out in accordance with JIS L1017, and an elongation rate at 2 cN/dtex is measured.
Dry heat shrinkage ratio: A shrinkage rate is measured based on the change in length of a cord upon heating in a load-unapplied state in accordance with method B prescribed in JIS L1017.
T-pull adhesion: A pull-out test is carried out in accordance with JIS L1017 to measure a pull-out adhesion force.
Fatigue of disc: A cord is fatigued using a GCF fatigue test machine and then the strength of the cord is measured in accordance with JIS L1017 to determine a strength retention rate. Compression/elongation strain=10%/5%, fatigue time: PET=72 hours, PEN=24 hours.
General durability: The strength of a cord which is removed from a tire after the completion of method A prescribed in JIS D4230 is determined in accordance with JIS L1017. A strength retention rate is determined by dividing the obtained cord strength by a strength of a cord removed from a new tire.
High-speed durability: The high-speed durability is evaluated under ECS-30 test conditions wherein the upper limit is (speed range)+30 km/hr.×10 min. After the completion of the evaluation, the tire is decomposed. The cord strength of a cord removed from the tire is measured in accordance with JIS L1017. A strength retention rate is determined by dividing the obtained cord strength by a strength of a cord removed from a new tire.
Handling stability Dry/Wet: The test is carried out in a test course owned by Toyo Tire Corporation. The car used in the test is one in which the tire is used as a standard tire.

A functional evaluation by three test drivers. An average value, wherein a perfect score is 5 and a standard score is 3.

“Dry” refers to a test carried out on a dry road, and “Wet” refers to a test in which the road is placed at a water depth of 1 mm and the running road is another one.

As shown in tables, it is demonstrated that the performance of a pneumatic tire according to the present invention which is produced from a polyester (e.g., polyethylene terephthalate or polyethylene naphthalate) using a raw material derived from a non-fossil raw material and the performance of a member constituting the pneumatic tire are the same levels as those pneumatic tires each produced using conventional raw material derived from fossil raw materials.

Consequently, according to the present invention, an environmental load-reducing pneumatic tire can be provided.

### INDUSTRIAL APPLICABILITY

According to the present invention, an environmental load-reducing pneumatic tire, carcass material or belt reinforcing material using an environmental load-reducing polyester (e.g., polyethylene terephthalate or polyethylene naphthalate) derived from a non-fossil raw material can be provided.

1. A pneumatic tire containing a polyester produced using a raw material derived from a non-fossil raw material.

2. The pneumatic tire according to claim 1, which contains a polyester in which a linear moiety or a cyclic moiety is produced using a raw material derived from a non-fossil raw material.

3. The pneumatic tire according to claim 1, which contains a polyester in which each of a linear moiety and a cyclic moiety is produced using a raw material derived from a non-fossil raw material.

4. The pneumatic tire according to claim 1, wherein the polyester is polyethylene terephthalate.

5. The pneumatic tire according to claim 1, wherein the polyester is polyethylene naphthalate.

6. A pneumatic tire in which polyethylene terephthalate produced using a raw material derived from a non-fossil raw material is used as a carcass material.

7. The pneumatic tire according to claim 6, wherein polyethylene terephthalate in which a linear moiety or a cyclic moiety is produced using a raw material derived from a non-fossil raw material is used as a carcass material.

8. The pneumatic tire according to claim 6, wherein polyethylene terephthalate in which each of a linear moiety and a cyclic moiety is produced using a raw material derived from a non-fossil raw material is used as a carcass material.

9-14. (canceled)

15. A pneumatic tire in which polyethylene naphthalate produced using a raw material derived from a non-fossil raw material is used as a belt reinforcing material.

16. The pneumatic tire according to claim 15, wherein polyethylene naphthalate in which a linear moiety or a cyclic moiety is produced using a raw material derived from a non-fossil raw material is used as a belt reinforcing material.

17. The pneumatic tire according to claim 15, wherein polyethylene naphthalate in which each of a linear moiety and a cyclic moiety is produced using a raw material derived from a non-fossil raw material is used as a belt reinforcing material.
